(19) United States
(12) Patent Application Publication
(10) Pub. No.: US 2004/0087334 A1
(43) Pub. Date: May 6, 2004

(54) High-output multi-mode mobile communication transceiver

(75) Inventor: Yasumasa Nishiyama, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/689,757

(22) Filed: Oct. 21, 2003

(30) Foreign Application Priority Data
Oct. 25, 2002 (JP) 2002-311280

(51) Int. Cl. H04M 1/00

(52) U.S. Cl. 455/550.1; 455/552.1

(57) ABSTRACT

A multi-mode mobile communication transceiver includes a transmission circuit that outputs at least transmission signals in the AMPS mode, and a reception circuit that receives at least reception signals in the AMPS mode. A booster includes a first terminal through which signals are connected to an antenna, a power amplifier circuit connected to the first terminal, and a reception-signal sending circuit connected to the first terminal. When the booster is connected with the multi-mode mobile communication transceiver, the transmission circuit is connected in series with the power amplifier circuit, and the reception-signal sending circuit is connected in series with the reception circuit.

### BACKGROUND OF THE INVENTION

1. Field of the Invention

The present invention relates to boosters used together with multi-mode mobile communication transceivers, for example, in cellular telephones, used in common for a plurality of modes.

2. Description of the Related Art

Cellular telephones used in the United States include the Code Division Multiple Access (CDMA) mode, the Advanced MobilePhone Service (AMPS) mode, and the Personal Communication Service (PCS) mode. Multi-mode mobile communication transceivers that allow two or three of the above-described modes to be handled in one cellular telephone have been put to practical use.

FIG. 3 is a circuit diagram illustrating the configuration of a known multi-mode mobile communication transceiver. A transmission signal in the 1900 MHz band used in the PCS mode or a transmission signal in the 800 MHz band used in the AMPS mode is input into a common power amplifier 33 via a bandpass filter 31 or 32, respectively. A 1900-MHz matching circuit 34 and a 800-MHz matching circuit 35 are provided at the output terminal of the power amplifier 33, and a duplexer 36 used for the PCS mode and a duplexer 37 used for the AMPS mode are provided at the output terminals of the matching circuits 34 and 35, respectively.

The input terminal of the duplexer 36 is connected to the matching circuit 34, and the output terminal thereof is connected to a reception circuit 38 for the PCS mode. The input terminal of the duplexer 37 is connected to the matching circuit 35, and the output terminal thereof is connected to a reception circuit 39 for the AMPS mode. The output terminals of the two duplexers 36 and 37 are connected to an antenna 41 via a diplexer 40 (for example, see published Japanese translations of PCT international publication for patent applications No. 2002-528946 (FIG. 2) as patent document 1).

The amplifier 33 in the above-configured transceiver is used in common for the PCS mode and the AMPS mode. Generally, in the AMPS mode, transmission signals only up to 28 dBm, i.e., power class III, can be output.

Multi-mode mobile communication transceivers are sometimes used for the Telematics system for emergency. In this system, the maximum transmission power of 36 dBm, i.e., power class I, is required. In order to respond to such a requirement, a high-output multi-mode mobile communication transceiver must be provided in addition to a known multimode mobile communication transceiver.

However, for the manufacturers of multi-mode mobile communication transceivers, the manufacturing management becomes complicated and the cost is increased if they have to possess two types of transceivers for different power classes.

### SUMMARY OF THE INVENTION

Accordingly, one advantage of the present invention is a booster that may be used together with a known low-output multi-mode mobile communication transceiver compatible with power class III so as to easily implement a high-output multi-mode mobile communication transceiver that can handle power class I if necessary.

In one aspect of the present invention, a high-output multi-mode mobile communication transceiver comprises: a multi-mode mobile communication transceiver used in common for a plurality of communication modes including at least an AMPS mode, and a booster connectable with the multi-mode mobile communication transceiver. The multi-mode mobile communication transceiver comprises: a transmission circuit configured to output at least transmission signals of the AMPS mode and a reception circuit configured to receive at least reception signals of the AMPS mode. The booster comprises: a first terminal through which signals in the booster are connected with a first antenna, a power amplifier circuit connected with the first terminal, and a reception-signal sending circuit connected with the first terminal. When the booster is attached to the multi-mode mobile communication transceiver, the transmission circuit is connected in series with the power amplifier circuit, and the reception-signal sending circuit is connected in series with the reception circuit.

With this configuration, the transmission power of the AMPS mode can be increased so as to easily implement a high-output multi-mode mobile communication transceiver that is compatible with power class I.

The booster may further include a second terminal connected with an input terminal of the power amplifier circuit and a third terminal connected with the reception-signal sending circuit. The multi-mode mobile communication transceiver may further include a fourth terminal through which signals in the transceiver are connected with a second antenna, a fifth terminal connectable with the second terminal, a sixth terminal connectable with the third terminal, a first switch that switches the transmission signal output from the transmission circuit to the fourth terminal or the fifth terminal to output the transmission signal, and a second switch that switches the reception signal input into the fourth terminal or the sixth terminal to the reception circuit. When the booster is connected with the multi-mode mobile communication transceiver, the second terminal may be connected to the fifth terminal, and the third terminal may be connected to the sixth terminal. With this configuration, the transmission circuit and the power amplifier circuit can be connected in series with each other, and the reception-signal sending circuit and the reception circuit can be connected in series with each other.

When an output terminal of the transmission circuit is connected to the fourth terminal by the first switch, an input terminal of the reception circuit may be connected to the fourth terminal by the second switch. With this arrangement, the transceiver can be used in modes other than the AMPS mode while allowing the booster to remain attached to the multi-mode mobile communication transceiver.

The booster may further include a duplexer that connects an output terminal of the power amplifier circuit and the reception-signal sending circuit with the first terminal, and the reception-signal sending circuit may contain a series circuit having a low-noise amplifier circuit and a variable attenuator. With this arrangement, the variable attenuator may be disposed more proximate to the third terminal than the low-noise amplifier circuit and insertion loss of the duplexer may be precisely compensated for so as to maintain the level of the reception signal.

The multi-mode mobile communication transceiver may further comprise another transmission circuit configured to output transmission signals of at least a mode different from the AMPS mode and another reception circuit configured to receive reception signals of the mode different from the AMPS mode. In this case, the other transmission and reception circuits remain unconnected with the booster circuit no matter the position of the first and second switches.

The transmission circuit may be configured to output transmission signals of at least a mode different from the AMPS mode and the reception circuit configured to receive reception signals of the mode different from the AMPS mode.

The multi-mode mobile communication transceiver and the booster may be encased in a portable housing.

The multi-mode mobile communication transceiver may further comprise a baseband processing circuit configured to output control signals that change operation of the transmission circuit, the reception circuit, and a state of connection between both the transmission and reception circuits and the booster circuit.

In another embodiment, the high-output multi-mode mobile communication transceiver comprises: a multi-mode mobile communication transceiver, a booster connectable with the multi-mode mobile communication transceiver, and a portable housing containing the multi-mode mobile communication transceiver and the booster. The multi-mode mobile communication transceiver comprises a transmission circuit configured to output transmission signals of a plurality of modes, a reception circuit configured to receive reception signals of the plurality of modes, and a first switch controlling connection between the transmission circuit and the booster and a second switch controlling connection between the reception circuit and the booster. The booster comprises a first terminal through which signals in the booster are connected with a first antenna, a power amplifier circuit connected with the first terminal, and a reception-signal sending circuit connected with the first terminal. The transmission circuit is connected in series with the power amplifier circuit and the reception-signal sending circuit is connected in series with the reception circuit when the first and second switches are switched such that the booster and the multi-mode mobile communication transceiver are connected, and the booster and the multi-mode mobile communication transceiver are connected for signals of at least one but fewer than all of the plurality of modes.

The booster may further comprise a second terminal connected with an input terminal of the power amplifier circuit and a third terminal connected with the reception-signal sending circuit, the multi-mode mobile communication transceiver may further comprise a fourth terminal through which signals other than those of the at least one mode are connected with a second antenna, a fifth terminal connectable with the second terminal, a sixth terminal connectable with the third terminal, the first switch switches the transmission signals output from the transmission circuit to the fourth terminal or the fifth terminal to output the transmission signals, and the second switch switches the reception signals input into the fourth terminal or the sixth terminal to the reception circuit. In this case, when the booster is connected with the multi-mode mobile communication transceiver, the second terminal is connected with the fifth terminal, and the third terminal is connected with the sixth terminal.

When an output terminal of the transmission circuit is connected with the fourth terminal by the first switch, an input terminal of the reception circuit may be connected with the fourth terminal by the second switch.

The booster may further comprise a duplexer that connects an output terminal of the power amplifier circuit and the reception-signal sending circuit to the first terminal, and the reception-signal sending circuit may contain a series circuit having a low-noise amplifier circuit and a variable attenuator. In this case, the variable attenuator may be disposed more proximate to the third terminal than the low-noise amplifier circuit and the reception-signal sending circuit compensates for insertion loss of the duplexer.

The multi-mode mobile communication transceiver may further comprise another transmission circuit configured to output transmission signals of at least a mode of the plurality of modes that is different from the at least one mode and another reception circuit configured to receive reception signals of the mode different from the at least one mode. In this case, the other transmission and reception circuits may remain unconnected with the booster circuit no matter the position of the first and second switches.

The transmission circuit may be configured to output transmission signals of at least a mode of the plurality of modes that is different from the at least one mode and the reception circuit configured to receive reception signals of the mode different from the at least one mode.

The transmission and reception circuits may be connected with the booster circuit for signals of only one mode of the plurality of modes. Only a single transceiver may be used for signals required to be output in different power classes at different times The high-output multi-mode mobile communication transceiver may further comprise a baseband processing circuit configured to output control signals that change operation of the transmission circuit, the reception circuit, and the first and second switches.

In another embodiment, a method of communicating comprises: transmitting transmission signals of a plurality of modes using a transmission circuit; receiving reception signals of the plurality of modes using a reception circuit; boosting a first set of signals of at least one but fewer than all of the plurality of modes using a booster; connecting the transmission circuit with the booster using a first switch and the reception circuit with the booster using a second switch the first set of signals, amplifying the first set of signals in the booster using a power amplifier circuit, which is series connected with the transmission circuit; communicating the first set of signals using a first antenna connected with a first terminal of the booster; and transmitting the first set of signals through a reception-signal sending circuit connected with the first terminal to the reception circuit, which is series connected with the reception-signal sending circuit.

The booster may further comprise a second terminal connected with an input terminal of the power amplifier circuit, and a third terminal connected with the reception-signal sending circuit, the multi-mode mobile communication transceiver may further comprise a fourth terminal, a fifth terminal connectable with the second terminal, and a sixth terminal connectable with the third terminal, and the method further comprise: switching the first switch such that transmission signals are output from the transmission circuit to the fourth terminal or the fifth terminal to output the transmission signals, and the second switch such that the reception signals are input into the fourth terminal or the sixth terminal to the reception circuits, connecting the second terminal with the fifth terminal and the third terminal with the sixth terminal when the booster is connected with the multi-mode mobile communication transceiver, and communicating signals other than the first set of signals externally using a second antenna connected with the fourth terminal.

The method may further comprise connecting at the same time (although perhaps not at the same instant) both an output terminal of the transmission circuit with the fourth terminal by the first switch and an input terminal of the reception circuit with the fourth terminal by the second switch.

The method may further comprise duplexing an output terminal of the power amplifier circuit and the reception-signal sending circuit with the first terminal using a duplexer in the booster, and compensating for insertion loss of the duplexer using a series circuit in the reception-signal sending circuit, the series circuit containing a low-noise amplifier circuit and a variable attenuator.

The method may further comprise outputting transmission signals of at least a mode that is different from the at least one mode using another transmission circuit, and receiving reception signals of the mode that is different from the at least one mode using another reception circuit. In this case, the method may further comprise leaving the other transmission and reception circuits unconnected with the booster circuit no matter the position of the first and second switches.

The method may further comprise outputting transmission signals of at least a mode that is different from the at least one mode using the transmission circuit and receiving reception signals of the mode that is different from the at least one mode using the reception circuit.

The method may further comprise connecting the transmission and reception circuits with the booster circuit for signals of only one mode. The method may further comprise using only a single transceiver for signals required to be output in different power classes at different times

The multi-mode mobile communication transceiver and the booster may be encased in a portable housing.

### BRIEF DESCRIPTION OF THE DRAWINGS

FIG. 1 is a circuit diagram illustrating the configuration of a high-output multi-mode mobile communication transceiver according to the present invention;

FIG. 2 is a circuit diagram of another configuration of a booster used in the high-output multi-mode mobile communication transceiver of the present invention; and

FIG. 3 is a circuit diagram illustrating the configuration of a known multi-mode mobile communication transceiver.

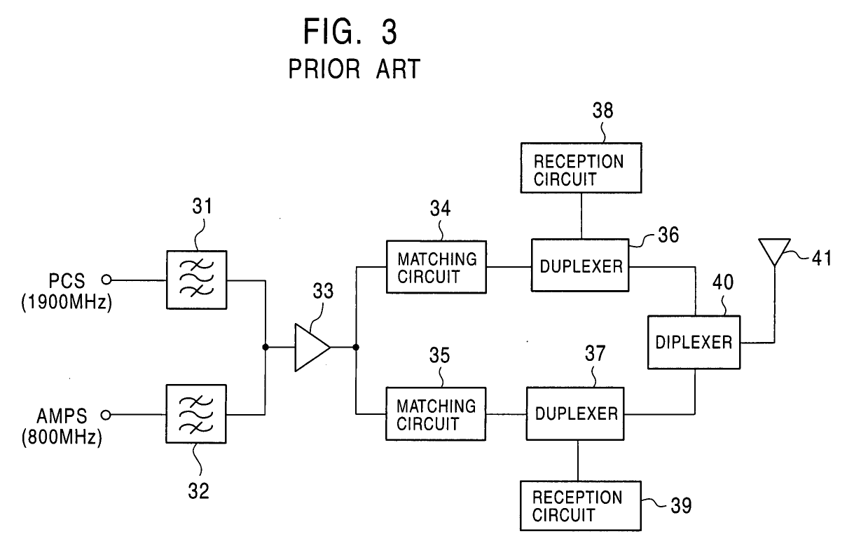

### DESCRIPTION OF THE PREFERRED EMBODIMENTS

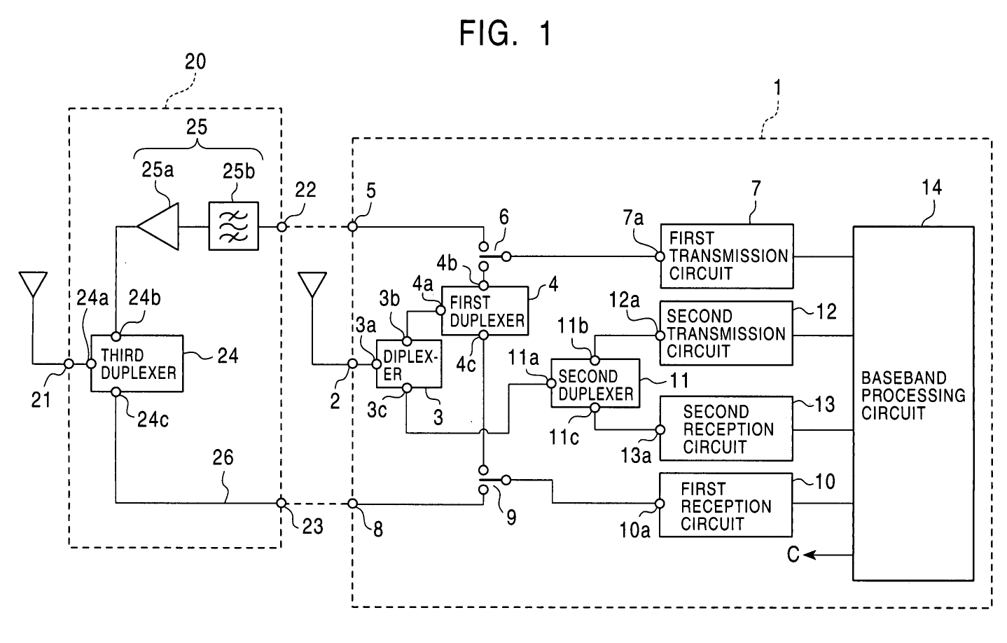

A high-output multi-mode mobile communication transceiver of the present invention is described below with reference to FIG. 1.

A low-output multi-mode mobile communication transceiver 1 is used in common for three modes, i.e., the AMPS mode and the CDMA mode used in the 800 MHz band and the PCS mode used in the 1900 MHz band. The transmission power of the AMPS mode which is output to a fourth terminal 2 through which signals are connected to an antenna is restricted to a maximum of 28 dBm, which corresponds to the standards of power class III. The fourth terminal 2 is connected to a common input/output terminal 3a of a diplexer 3 for separating transmission and reception signals in the 800 MHz band and transmission and reception signals in the 1900 MHz band. An 800-MHz input/output terminal 3b of the diplexer 3 is connected to an input/output terminal 4a of a first duplexer 4. Either of an input terminal 4b of the first duplexer 4 or a fifth terminal 5 through which transmission signals are output is connected to an output terminal 7a of a first transmission circuit 7 by a first switch 6. The first transmission circuit 7 is used in common for transmitting signals in the AMPS mode and the CDMA mode.

Either of an output terminal 4c of the first duplexer 4 or a sixth terminal 8 through which reception signals are input is connected to an input terminal l0a of a first reception circuit 10 by a second switch 9. The first reception circuit 10 is used in common for receiving signals in the AMPS mode and the CDMA mode.

The first switch 6 and the second switch 9 are operated in cooperation with each other. When the output terminal 7a of the first transmission circuit 7 is connected to the fifth terminal 5, the input terminal 10a of the first reception circuit 10 is connected to the sixth terminal 8. When the output terminal 7a of the first transmission circuit 7 is connected to the input terminal 4b of the first duplexer 4, the input terminal l0a of the first reception circuit 10 is connected to the output terminal 4c of the first duplexer 4.

A 1900-MHz output terminal 3c of the diplexer 3 is connected to an input/output terminal 11a of a second duplexer 11. An input terminal 11b of the second duplexer 11 is connected to an output terminal 12a of a second transmission circuit 12. The second transmission circuit 12 is used for transmitting signals in the PCS mode. An output terminal 11c of the second duplexer 11 is connected to an input terminal 13a of a second reception circuit 13. The second reception circuit 13 is used for receiving signals in the PCS mode.

A baseband processing circuit 14 is provided at the input terminals of the first and second transmission circuits 7 and 12 and at the output terminals of the first and second reception circuits 10 and 13, and a plurality of control signals C are output from the baseband processing circuit 14 so as to change the operations of the first and second transmission circuits 7 and 12 and the first and second reception circuits 10 and 13 and also to change the connection of the first and second switches 6 and 9.

When the transceiver 1 is solely used, the first transmission circuit 7 is connected to the first duplexer 4 by the first switch 6, and the first reception circuit 10 is connected to the first duplexer 4 by the second switch 9.

Accordingly, since the first transmission circuit 7 and the first reception circuit 10 are connected to the fourth terminal 2 via the first duplexer 4 and the diplexer 3, a transmission signal of the corresponding mode is output to the antenna via the fourth terminal 2. In this case, the power level when the AMPS-mode transmission signal from the first transmission circuit 7 is output to the fourth terminal 2 is at a maximum of 28 dBm compatible with class III. Reception signals of the corresponding modes received by the antenna are input into the first and second reception circuits 10 and 13 via the fourth terminal 2.

A booster 20 is used for increasing the transmission power of AMPS-mode signals to 36 dBm so that they can be compatible with power class I. The booster 20 is provided with a first terminal 21 through which signals are connected to the antenna, a second terminal 22 through which transmission signals are input, and a third terminal 23 through which reception signals are output. The booster 20 is attachable to the transceiver 1, in which case, the second terminal 22 is connected to the fifth terminal 5, and the third terminal 23 is connected to the sixth terminal 8.

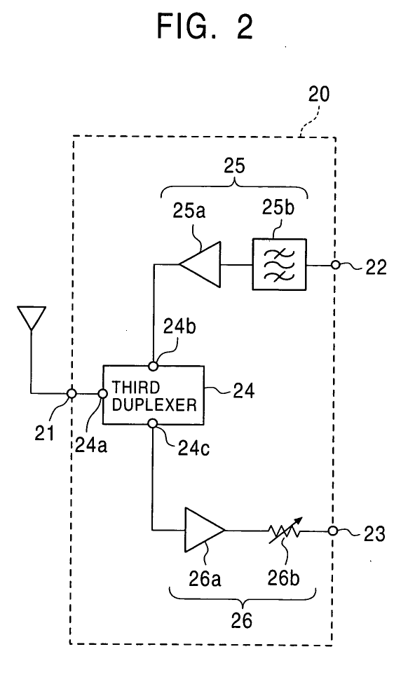

The first terminal 21 is connected to an input/output terminal 24a of a third duplexer 24, and a transmission-signal sending circuit 25 is inserted between an input terminal 24b of the third duplexer 24 and the second terminal 22. The transmission-signal sending circuit 25 includes a power amplifier circuit 25a and a bandpass filter 25b disposed before the power amplifier circuit 25a. A reception-signal sending circuit 26 is inserted between an output terminal 24c of the duplexer 24 and the third terminal 23. The reception-signal sending circuit 26 may be simply a line (i.e. a direct electrical connection between the output terminal 24c of the duplexer 24 and the third terminal 23), as shown in FIG. 1, or may contain a low-noise amplifier circuit 26a and a variable attenuator 26b disposed more proximate to the third terminal 23 than the low-noise amplifier circuit 26a, as shown in FIG. 2. The attenuation of the variable attenuator 26b is controlled by control signal C from the processing circuit 14.

When increasing the AMPS-mode transmission power to class I by attaching the booster 20 to the transceiver 1, the output terminal 7a of the first transmission circuit 7 is connected to the fifth terminal 5 by the first switch 6, and the input terminal 10a of the first reception circuit 10 is connected to the sixth terminal 8 by the second switch 9. Then, the first transmission circuit 7 is connected in series with the power amplifier circuit 25a, and the first reception circuit 10 is connected in series with the reception-signal sending circuit 26. Thus, a transmission signal is amplified by the power amplifier circuit 25a so as to form a high-output multi-mode mobile communication transceiver. When the reception-signal sending circuit 26 of the booster 20 contains the low-noise amplifier circuit 26a and the variable attenuator 26b, insertion loss of the third duplexer 24 can be precisely compensated for so as to maintain the level of the reception signal.

The booster 20 may remain connected to the transceiver 1, in which case, the first transmission circuit 7 is connected to the first duplexer 4 by the first switch 6, and the first reception circuit 10 is connected to the first duplexer 4 by the second switch 9, and then, the transceiver 1 can be used in modes other than the AMPS mode. The multi-mode mobile communication transceiver 1 and booster 20 are contained within the same portable housing, e.g. a cellular telephone housing.

While particular embodiments of the present invention have been shown and described, modifications may be made by one skilled in the art without altering the invention. It is therefore intended in the appended claims to cover such changes and modifications which follow in the true spirit and scope of the invention.

What is claimed is:

1. A high-output multi-mode mobile communication transceiver comprising:
a multi-mode mobile communication transceiver used in common for a plurality of communication modes including at least an AMPS mode; and
a booster connectable with said multi-mode mobile communication transceiver,
said multi-mode mobile communication transceiver comprising:
a transmission circuit configured to output at least transmission signals of the AMPS mode; and
a reception circuit configured to receive at least reception signals of the AMPS mode,
said booster comprising:
a first terminal through which signals in the booster are connected with a first antenna;
a power amplifier circuit connected with the first terminal; and
a reception-signal sending circuit connected with the first terminal,
wherein, when said booster is attached to said multi-mode mobile communication transceiver, the transmission circuit is connected in series with the power amplifier circuit, and the reception-signal sending circuit is connected in series with the reception circuit.

2. A high-output multi-mode mobile communication transceiver according to claim 1, wherein:
said booster further comprises a second terminal connected with an input terminal of the power amplifier circuit, and a third terminal connected with the reception-signal sending circuit;
said multi-mode mobile communication transceiver further comprises a fourth terminal through which signals in the transceiver are connected with a second antenna, a fifth terminal connectable with the second terminal, a sixth terminal connectable with the third terminal, a first switch that switches the transmission signals output from the transmission circuit to the fourth terminal or the fifth terminal to output the transmission signals, and a second switch that switches the reception signals input into the fourth terminal or the sixth terminal to the reception circuit; and
when said booster is connected with said multi-mode mobile communication transceiver, the second terminal is connected with the fifth terminal, and the third terminal is connected with the sixth terminal.

3. A high-output multi-mode mobile communication transceiver according to claim 2, wherein, when an output terminal of the transmission circuit is connected with the fourth terminal by the first switch, an input terminal of the reception circuit is connected with the fourth terminal by the second switch.

4. A high-output multi-mode mobile communication transceiver according to claim 2, wherein said booster further comprises a duplexer that connects an output terminal of the power amplifier circuit and the reception-signal sending circuit with the first terminal, and the reception-signal sending circuit contains a series circuit having a low-noise amplifier circuit and a variable attenuator.

5. A high-output multi-mode mobile communication transceiver according to claim 1, wherein said multi-mode mobile communication transceiver further comprises another transmission circuit configured to output transmission signals of at least a mode different from the AMPS mode and another reception circuit configured to receive reception signals of the mode different from the AMPS mode.

6. A high-output multi-mode mobile communication transceiver according to claim 5, wherein the other transmission and reception circuits remain unconnected with the booster circuit no matter the position of the first and second switches.

7. A high-output multi-mode mobile communication transceiver according to claim 1, wherein the transmission circuit is configured to output transmission signals of at least a mode different from the AMPS mode and the reception circuit is configured to receive reception signals of the mode different from the AMPS mode.

8. A high-output multi-mode mobile communication transceiver according to claim 1, wherein the multi-mode mobile communication transceiver and the booster are encased in a portable housing.

9. A high-output multi-mode mobile communication transceiver according to claim 4, wherein the variable attenuator is disposed more proximate to the third terminal than the low-noise amplifier circuit, and the reception-signal sending circuit compensates for insertion loss of the duplexer.

10. A high-output multi-mode mobile communication transceiver according to claim 1, further comprising a baseband processing circuit configured to output control signals that change operation of the transmission circuit, the reception circuit, and a state of connection between both the transmission and reception circuits and the booster circuit.

11. A high-output multi-mode mobile communication transceiver comprising:
a multi-mode mobile communication transceiver;
a booster connectable with the multi-mode mobile communication transceiver; and
a portable housing containing the multi-mode mobile communication transceiver and the booster,
the multi-mode mobile communication transceiver comprising:
a transmission circuit configured to output transmission signals of a plurality of modes;
a reception circuit configured to receive reception signals of the plurality of modes; and
a first switch controlling connection between the transmission circuit and the booster and a second switch controlling connection between the reception circuit and the booster,
the booster comprising:
a first terminal through which signals in the booster are connected with a first antenna;
a power amplifier circuit connected with the first terminal; and
a reception-signal sending circuit connected with the first terminal,
wherein the transmission circuit is connected in series with the power amplifier circuit and the reception-signal sending circuit is connected in series with the reception circuit when the first and second switches are switched such that the booster and the multi-mode mobile communication transceiver are connected, and the booster and the multi-mode mobile communication transceiver are connected for signals of at least one but fewer than all of the plurality of modes.

12. A high-output multi-mode mobile communication transceiver according to claim 11, wherein:
the booster further comprises a second terminal connected with an input terminal of the power amplifier circuit, and a third terminal connected with the reception-signal sending circuit;
the multi-mode mobile communication transceiver further comprises a fourth terminal through which signals other than those of the at least one mode are connected with a second antenna, a fifth terminal connectable with the second terminal, a sixth terminal connectable with the third terminal, the first switch switches the transmission signals output from the transmission circuit to the fourth terminal or the fifth terminal to output the transmission signals, and the second switch switches the reception signals input into the fourth terminal or the sixth terminal to the reception circuit; and
when the booster is connected with the multi-mode mobile communication transceiver, the second terminal is connected with the fifth terminal, and the third terminal is connected with the sixth terminal.

13. A high-output multi-mode mobile communication transceiver according to claim 12, wherein, when an output terminal of the transmission circuit is connected with the fourth terminal by the first switchman input terminal of the reception circuit is connected with the fourth terminal by the second switch.

14. A high-output multi-mode mobile communication transceiver according to claim 12, wherein the booster further comprises a duplexer that connects an output terminal of the power amplifier circuit and the reception-signal sending circuit to the first terminal, and the reception-signal sending circuit contains a series circuit having a low-noise amplifier circuit and a variable attenuator.

15. A high-output multi-mode mobile communication transceiver according to claim 11, wherein the multi-mode mobile communication transceiver further comprises another transmission circuit configured to output transmission signals of at least a mode of the plurality of modes that is different from the at least one mode and another reception circuit configured to receive reception signals of the mode different from the at least one mode.

16. A high-output multi-mode mobile communication transceiver according to claim 15, wherein the other transmission and reception circuits remain unconnected with the booster circuit no matter the position of the first and second switches.

17. A high-output multi-mode mobile communication transceiver according to claim 11, wherein the transmission circuit is configured to output transmission signals of at least a mode of the plurality of modes that is different from the at least one mode and the reception circuit is configured to receive reception signals of the mode different from the at least one mode.

18. A high-output multi-mode mobile communication transceiver according to claim 11, wherein the transmission and reception circuits are connected with the booster circuit for signals of only one mode of the plurality of modes.

19. A high-output multi-mode mobile communication transceiver according to claim 14, wherein the variable attenuator is disposed more proximate to the third terminal than the low-noise amplifier circuit and the reception-signal sending circuit compensates for insertion loss of the duplexer.

20. A high-output multi-mode mobile communication transceiver according to claim 11, further comprising a baseband processing circuit configured to output control signals that change operation of the transmission circuit, the reception circuit, and the first and second switches.

21. A high-output multi-mode mobile communication transceiver according to claim 11, wherein only a single transceiver is used for signals required to be output in different power classes at different times.

22. A method of communicating comprising:
transmitting transmission signals of a plurality of modes using a transmission circuit;
receiving reception signals of the plurality of modes using a reception circuit;
boosting a first set of signals of at least one but fewer than all of the plurality of modes using a booster;
connecting the transmission circuit with the booster using a first switch and the reception circuit with the booster using a second switch the first set of signals,
amplifying the first set of signals in the booster using a power amplifier circuit, which is series connected with the transmission circuit;
communicating the first set of signals using a first antenna connected with a first terminal of the booster; and
transmitting the first set of signals through a reception-signal sending circuit connected with the first terminal to the reception circuit, which is series connected with the reception-signal sending circuit.

23. A method according to claim 22, wherein:
the booster further comprises a second terminal connected with an input terminal of the power amplifier circuit, and a third terminal connected with the reception-signal sending circuit,
the multi-mode mobile communication transceiver further comprises a fourth terminal, a fifth terminal connectable with the second terminal, and a sixth terminal connectable with the third terminal, and
the method further comprises:
switching the first switch such that transmission signals are output from the transmission circuit to the fourth terminal or the fifth terminal to output the transmission signals, and the second switch such that the reception signals are input into the fourth terminal or the sixth terminal to the reception circuits,
connecting the second terminal with the fifth terminal and the third terminal with the sixth terminal when the booster is connected with the multi-mode mobile communication transceiver, and
communicating signals other than the first set of signals externally using a second antenna connected with the fourth terminal.

24. A method according to claim 23, further comprising connecting at the same time both an output terminal of the transmission circuit with the fourth terminal by the first switch and an input terminal of the reception circuit with the fourth terminal by the second switch.

25. A method according to claim 23, further comprising:
duplexing an output terminal of the power amplifier circuit and the reception-signal sending circuit with the first terminal using a duplexer in the booster; and
compensating for insertion loss of the duplexer using a series circuit in the reception-signal sending circuit, the series circuit containing a low-noise amplifier circuit and a variable attenuator.

26. A method according to claim 22, further comprising:
outputting transmission signals of at least a mode that is different from the at least one mode using another transmission circuit; and
receiving reception signals of the mode that is different from the at least one mode using another reception circuit.

27. A method according to claim 26, further comprising leaving the other transmission and reception circuits unconnected with the booster circuit no matter the position of the first and second switches.

28. A method according to claim 22, further comprising
outputting transmission signals of at least a mode that is different from the at least one mode using the transmission circuit; and
receiving reception signals of the mode that is different from the at least one mode using the reception circuit.

29. A method according to claim 22, further comprising connecting the transmission and reception circuits with the booster circuit for signals of only one mode.

30. A method according to claim 22, wherein the multimode mobile communication transceiver and the booster are encased in a portable housing.

31. A method according to claim 22, further comprising
using only a single transceiver for signals required to be output in different power classes at different times.
